(19) United States
(12) Patent Application Publication
(10) Pub. No.: US 2023/0256519 A1
(43) Pub. Date: Aug. 17, 2023

(54) SYSTEMS FOR MICROTOMING A PIPE

(71) Applicant: Daniel Rapp, Beaverton, OR (US)

(72) Inventor: Daniel Rapp, Beaverton, OR (US)

(21) Appl. No.: 17/673,546

(22) Filed: Feb. 16, 2022

(51) Int. Cl. B23B 5/12; B23B 3/26

(52) U.S. Cl. CPC B23B 5/12; B23B 3/26

(57) ABSTRACT

Systems for circumferentially microtoming a pipe having a longitudinal axis. The systems include a frame, a lathe, a carriage, a cutting tool, and an actuator. The lathe is mounted to the frame and configured to support and rotate the pipe about the longitudinal axis of the pipe. The carriage is operatively supported on the frame proximate the pipe. The cutting tool selectively engages the pipe. The actuator is operatively supported on the frame and configured to move the carriage to different radial positions perpendicular to the longitudinal axis of the pipe. In some examples, the system includes a position sensor, a computer display, and/or a controller.

### BACKGROUND

The present disclosure relates generally to material sampling systems. In particular, systems for microtoming a pipe are described.

Testing materials is a common practice to assess the properties of the materials. For example, a material scientist may seek to evaluate a material's stability. Additionally or alternatively, a material scientist may seek to evaluate how components of a material are distributed throughout the material.

Plastic pipes are often tested by material scientists to assess properties of the plastic and its suitability for use in various applications. A material scientist may evaluate how plastic additives introduced during the manufacturing process of the plastic pipe are comprised in the resulting pipe. For example, the material scientist may compare the design parameters for the additives with real world measurements. This testing helps the material scientist to understand if the expected percentages of additives in the pipe wall are present after manufacturing and if the additives are evenly distributed throughout the pipe wall.

Microtoming is a technique for obtaining samples of a material for testing. Microtoming allows material scientists to evaluate levels of additives in a material and the material's stability. The process to microtome plastic is not new; however, conventional microtoming systems are designed to microtome biologic material in the health industry. Conventional microtome systems are expensive and do not cut individual layers around the circumference of a pipe wall consistently or with sufficient precision.

Conventional microtome systems currently rely on linear movement of the sampling material across a sharp and steady fixed blade. The method of operation of conventional microtome systems is not well suited for microtoming the wall of a pipe. Conventional microtome systems require technicians to calculate each microtoming position manually and with scientific certainty for different pipe wall thicknesses or different samples of the same size. As a result, conventional microtome systems are not commercially feasible for microtoming pipes.

It would be desirable to have a microtome system that was commercially feasible for microtoming pipes. It would be advantageous if a microtome system provided scientifically repeatable microtomes across different pipe wall thickness and different samples. It would beneficial if a microtome system could obtain layers of plastic pipe at precise levels around the circumference of the pipe wall.

Thus, there exists a need for microtome systems that improve upon and advance the design of known microtome systems. Examples of new and useful microtome systems relevant to the needs existing in the field are discussed below.

### SUMMARY

The present disclosure is directed to systems for circumferentially microtoming a pipe having a longitudinal axis. The systems include a frame, a lathe, a carriage, a cutting tool, and an actuator. The lathe is mounted to the frame and configured to support and rotate the pipe about the longitudinal axis of the pipe. The carriage is operatively supported on the frame proximate the pipe. The cutting tool selectively engages the pipe. The actuator is operatively supported on the frame and configured to move the carriage to different radial positions perpendicular to the longitudinal axis of the pipe. In some examples, the system includes a position sensor, a computer display, and/or a controller.

### BRIEF DESCRIPTION OF THE DRAWINGS

FIG. 1 is a perspective view of a system for microtoming a pipe.

FIG. 2 is a top view of the system shown in FIG. 1.

FIG. 3 is a front view of the system shown in FIG. 1.

FIG. 4 is a left side view of a system shown in FIG. 1.

FIG. 5A is a top view of a cutting tool included in the system shown in FIG. 1.

FIG. 5B is a side view of the cutting tool shown in FIG. 5A.

FIG. 5C is a perspective view of the cutting tool shown in FIG. 5A.

FIG. 6A is a close up view of an actuator and carriage included in the system shown in FIG. 1 with the cutting tool spaced from a pipe.

FIG. 6B is a close up view of the actuator and carriage shown in FIG. 6A with the cutting tool cutting a peel from the pipe.

### DETAILED DESCRIPTION

The disclosed microtome systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various microtome systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Systems for Microtoming a Pipe

With reference to the figures, systems for microtoming a pipe will now be described. The microtome systems discussed herein function to cut thin circumferential peels from a circular pipe wall. The microtome systems enable cutting peels at thickness that allow for testing using ASTM E168 Standard Practices for General Techniques of Infrared Quantitative Analysis (FTIR). Sample peels using the microtome systems herein may be cut to 200 μm (0.008-inches) thick (or other thicknesses) and allow samples to be tested using FTIR transmission. These same samples can also be used in ASTM D3895 Oxidative-Induction Time of Polyolefins by Differential Scanning Calorimetry (DSC-OIT).

The reader will appreciate from the figures and description below that the presently disclosed microtome systems address many of the shortcomings of conventional microtome systems. For example, the novel microtome systems described below do not rely on linear movement of the sampling material across a sharp and steady fixed blade, which is not well suited for microtoming the wall of a pipe. Instead, the novel microtome systems described herein utilize a superior operating method for circular pipes; namely, rotating the sample material around a longitudinal axis and moving a cutting blade into the rotating sample material.

The novel microtome systems described in this document do not require technicians to calculate each microtoming position manually and with scientific certainty for different pipe wall thicknesses or different samples of the same size. As a result, the novel microtome systems disclosed herein are commercially feasible for microtoming pipes. Further, the novel microtome systems discussed below provide scientifically repeatable microtomes across different pipe wall thickness and different samples. Advantageously, the novel microtome systems described in this document enable obtaining layers of plastic pipe at precise levels around the circumference of the pipe wall.

Contextual Details

Ancillary features relevant to the microtome systems described herein will first be described to provide context and to aid the discussion of the microtome systems.

Material Tested

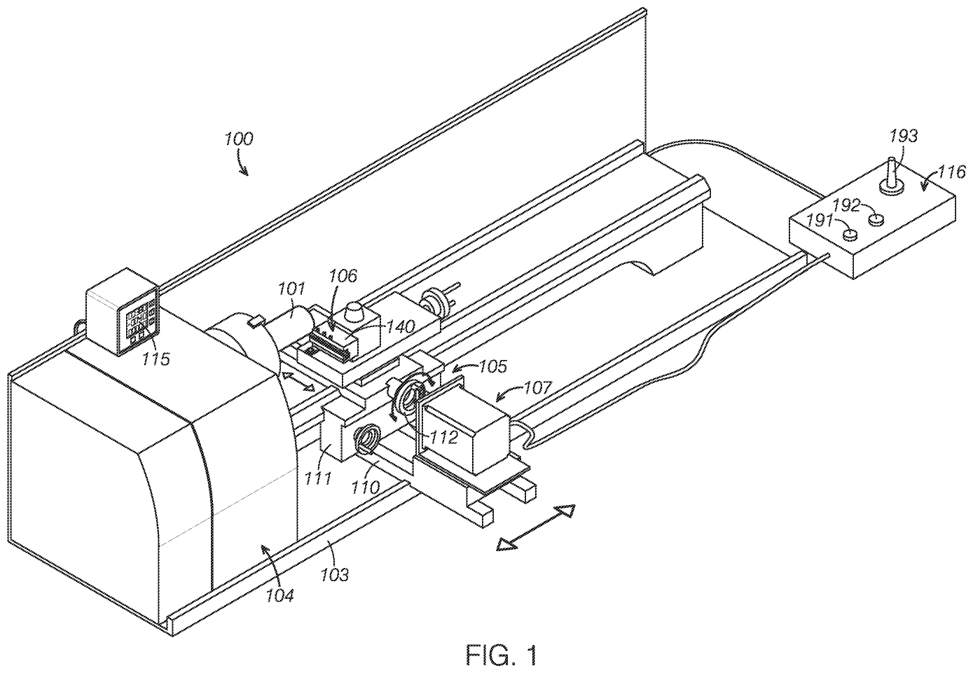

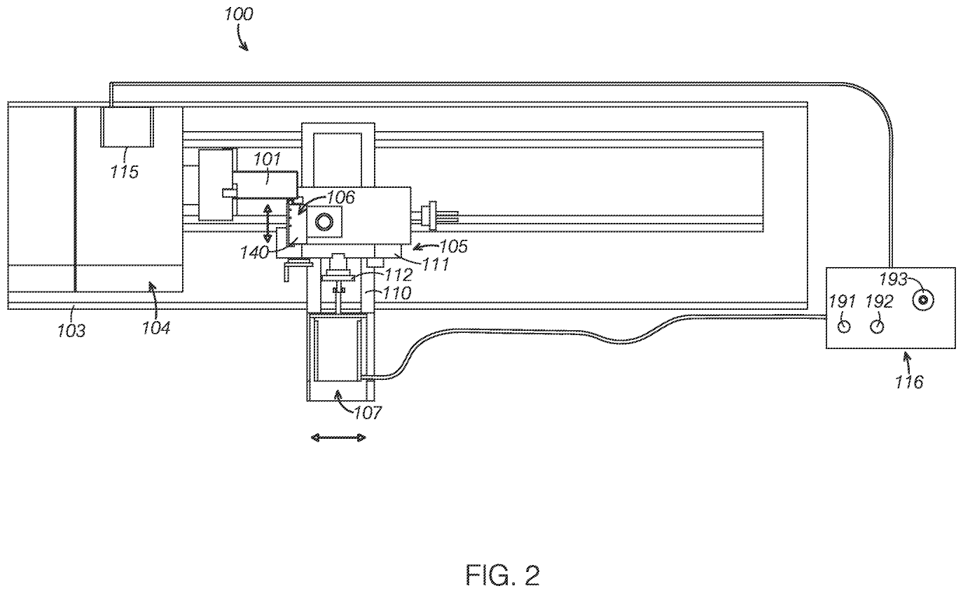

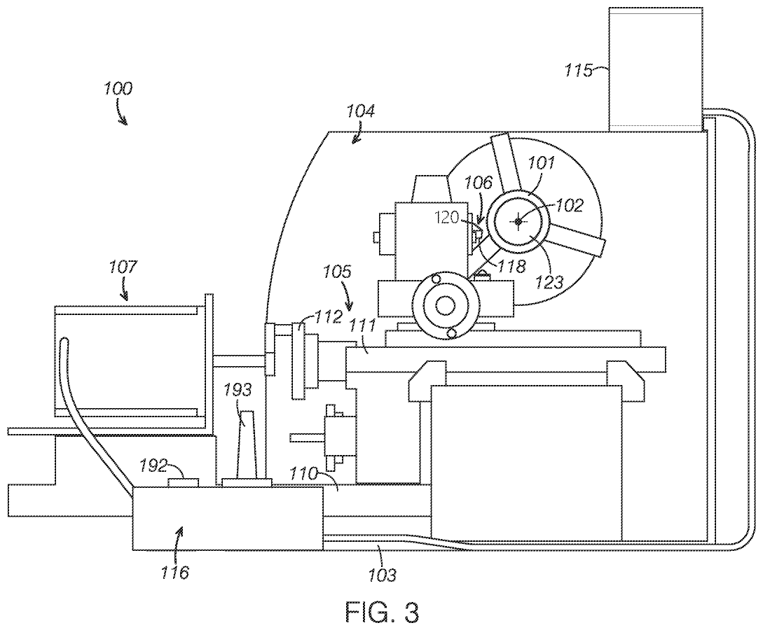

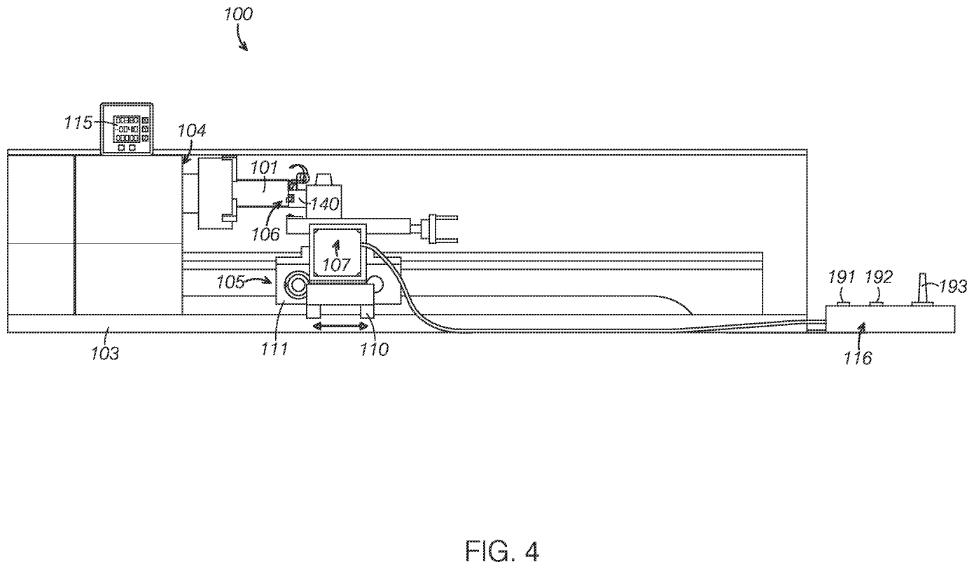

The microtome systems discussed in this document are often used to microtome a pipe, such as pipe 101 shown in FIGS. 1-4. However, the microtome systems may additionally or alternatively test cylindrical rods or other cylindrical members. Pipe 101 extends longitudinally and, as depicted in FIG. 3, has a longitudinal axis 102.

The pipe or rod may be any currently known or later developed type of pipe or rod. The reader will appreciate that a variety of pipe and rod types exist and could be used in place of the pipe shown in the figures. In addition to the types of pipes and rods existing currently, it is contemplated that the systems described herein could be used to test new types of pipes developed in the future.

The size and shape of the pipe or rod may be varied as needed for a given application. In some examples, the pipe or rod is larger relative to the other components than depicted in the figures. In other examples, the pipe or rod is smaller relative to the other components than depicted in the figures. Further, the reader should understand that the pipe or rod and the other components may all be larger or smaller than described herein while maintaining their relative proportions.

In the present example, the pipe is composed of plastic. However, the pipe or rod may be composed of any currently known or later developed material suitable for microtoming. Suitable materials include metals, polymers, wood, and composite materials. Different cutting blades may be selected based on the material being tested.

### Microtome System Embodiment One

With reference to FIGS. 1-6B, a microtome system 100 will now be described as a first example of a microtome system. The reader can see in FIGS. 1-6B that microtome system 100 functions to circumferentially microtome pipe 101.

As one specific example, microtome system 100 cuts thin circumferential peels from around the pipe wall of pipe 101 at thickness that allow for testing using ASTM E168 Standard Practices for General Techniques of Infrared Quantitative Analysis (FTIR). Microtome system 100 cuts sample peels that are 200 μm (0.008-inches) thick to allow samples to be tested using FTIR transmission. These same samples can also be used in ASTM D3895 Oxidative-Induction Time of Polyolefins by Differential Scanning Calorimetry (DSC-OIT). Importantly, microtome system 100 can be adjusted to cut peels thicker or thinner than 200 μm as needed.

As depicted in FIGS. 1-6B, microtome system 100 includes a frame 103, a lathe 104, a carriage 105, a cutting tool 106, an actuator 107, a position sensor (not pictured), a computer display 115, and a controller 116. In other examples, the system includes fewer components than depicted in the figures, such as not including a frame, a computer display, or a position sensor. In certain examples, the system includes additional or alternative components than depicted in the figures.

The size and shape of the system may be varied as needed for a given application. In some examples, the system is larger or smaller.

Frame

Frame 103 functions to support components of microtome system 100. As shown in FIGS. 1-6B, frame 103 directly or indirectly supports lathe 104, carriage 105, actuator 107, the position sensor, computer display 115, and controller 116.

The frame may be any currently known or later developed type of frame. The reader will appreciate that a variety of frame types exist and could be used in place of the frame shown in the figures. In addition to the types of frames existing currently, it is contemplated that the systems described herein could incorporate new types of frames developed in the future.

The size and shape of the frame may be varied as needed for a given application. In some examples, the frame is larger relative to the other components than depicted in the figures. In other examples, the frame is smaller relative to the other components than depicted in the figures. Further, the reader should understand that the frame and the other components may all be larger or smaller than described herein while maintaining their relative proportions.

In the present example, the frame is composed of metal. However, the frame may be composed of any currently known or later developed material suitable for the applications described herein for which it is used. Suitable materials include metals, polymers, ceramics, wood, and composite materials.

Controller

The role of controller 116 is to control operation of selected components of microtome system 100. In the example depicted in the figures, controller 116 is configured to selectively actuate actuator 107 based on programmed instructions. Controller 116 is further configured to selectively activate lathe 104 to rotate pipe 101 based on programmed instructions.

As shown in Figs. ______, controller 116 includes a first switch 191, a second switch 192, and a joystick 193. In other examples, the controller is configured differently, such as not including a joystick and/or using a touchscreen interface to activate the switches.

The controller may be any currently known or later developed type of controller. The reader will appreciate that a variety of controller types exist and could be used in place of the controller shown in the figures. In addition to the types of controllers existing currently, it is contemplated that the systems described herein could incorporate new types of controllers developed in the future.

Lathe

The role of lathe 104 is to rotate pipe 101 about longitudinal axis 102. With reference to FIGS. 1-4, lathe 104 is mounted to frame 103.

As shown in FIGS. 14, lathe 104 is configured to support pipe 101 and rotate it about longitudinal axis 102. To assist with supporting pipe 101, the reader can see in FIG. 3 that lathe 104 includes a support mount 123. Support mount 123 extends coaxially with longitudinal axis 102. Support mount 123 is configured to support pipe 101 from inside pipe 101.

The size and shape of the support mount may be varied as needed for a given size pipe. The size of the support mount may be selected to complement the inner diameter of the pipe.

In some examples, the support mount is larger relative to the other components than depicted in the figures. In other examples, the support mount is smaller relative to the other components than depicted in the figures. Further, the reader should understand that the support mount and the other components may all be larger or smaller than described herein while maintaining their relative proportions.

In the present example, support mount 123 is composed of wood. However, the support mount may be composed of any currently known or later developed material suitable for the applications described herein for which it is used. Suitable materials include metals, polymers, ceramics, wood, and composite materials.

In the example shown in the figures, lathe 104 is configured to be controlled by controller 116 operating pursuant to programmed instructions. The programmed instructions include instructions to rotate pipe 101 over a selected angle. The selected angle will determine the length of the peel microtomed from the pipe and different testing specifications may require different peel lengths.

In the present example, the selected angle is 720 degrees. However, the selected angle may be any angle suitable for a given testing paradigm. For example, the selected angle may be 360 degrees, 180 degrees, 90 degrees, and others. Of course, the selected angle could be angles other than integer multiples of pi, such as 721, 719, 359, 358, or 357 degrees and the like.

The lathe may be any currently known or later developed type of lathe. The reader will appreciate that a variety of lathe types exist and could be used in place of the lathe shown in the figures. In addition to the types of lathes existing currently, it is contemplated that the systems described herein could incorporate new types of lathes developed in the future.

Carriage

The role of carriage 105 is to movably support cutting tool 106. In particular, carriage 105 functions to selectively move cutting tool 106 into precise positions to cut a peel of selected thickness from pipe 101.

With reference to FIGS. 1-4, 6A, and 6B, carriage 105 is supported on frame 103 proximate pipe 101. As shown in FIGS. 1-4, 6A, and 6B, carriage 105 includes a rail 110, a sled 111, and a position dial 112.

Rail

Rail 110 serves to support sled 111. In particular, rail 110 provides a bearing surface over which sled 111 may translate in a defined direction back and forth relative to pipe 101.

The rail may be any currently known or later developed type of rail. A variety of rail types exist and could be used in place of the rail shown in the figures. In addition to the types of rails existing currently, it is contemplated that the systems described herein could incorporate new types of rails developed in the future.

The size and shape of the rail may be vaned as needed for a given application. In some examples, the rail is larger relative to the other components than depicted in the figures. In other examples, the rail is smaller relative to the other components than depicted in the figures. Further, the reader should understand that the rail and the other components may all be larger or smaller than described herein while maintaining their relative proportions.

In the present example, the rail is composed of metal. However, the sled may be composed of any currently known or later developed material suitable for the applications described herein for which it is used. Suitable materials include metals, polymers, ceramics, wood, and composite materials.

Sled

Sled 111 functions to support cutting tool 106. As depicted in FIGS. 1-4, 6A, and 6B, sled 111 is moveably mounted on rail 110 and moveably supports cutting tool 106.

The sled may be any currently known or later developed type of sled. The reader will appreciate that a variety of sled types exist and could be used in place of the sled shown in the figures. In addition to the types of sled existing currently, it is contemplated that the systems described herein could incorporate new types of sled developed in the future.

The size and shape of the sled may be varied as needed for a given application. In some examples, the sled is larger relative to the other components than depicted in the figures. In other examples, the sled is smaller relative to the other components than depicted in the figures. Further, the reader should understand that the sled and the other components may all be larger or smaller than described herein while maintaining their relative proportions.

In the present example, the sled is composed of metal. However, the sled may be composed of any currently known or later developed material suitable for the applications described herein for which it is used. Suitable materials include metals, polymers, ceramics, wood, and composite materials.

Position Dial

The reader can see in FIGS. 1-4, 6A, and 6B that position dial 112 configured to translate sled 111 relative to rail 110 when position dial 112 rotates.

The position dial may be any currently known or later developed type of position dial. A variety of position dial types exist and could be used in place of the position dial shown in the figures. In addition to the types of position dials existing currently, it is contemplated that the systems described herein could incorporate new types of position dials developed in the future.

The size and shape of the position dial may be varied as needed for a given application. In some examples, the position dial is larger relative to the other components than depicted in the figures. In other examples, the position dial is smaller relative to the other components than depicted in the figures. Further, the reader should understand that the position dial and the other components may all be larger or smaller than described herein while maintaining their relative proportions.

In the present example, the position dial is composed of metal. However, the sled may be composed of any currently known or later developed material suitable for the applications described herein for which it is used. Suitable materials include metals, polymers, ceramics, wood, and composite materials.

Cutting Tool

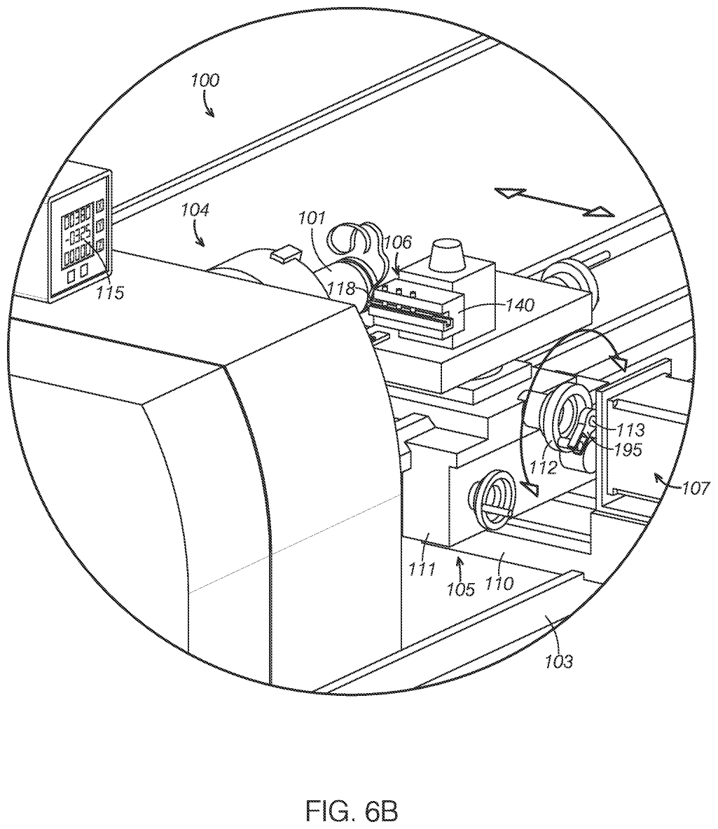

Cutting tool 106 functions to cut peels of material off pipe 101, which is also known as microtoming a pipe. With reference to FIGS. 14 and 6B, cutting tool 106 selectively engages pipe 101 when moved towards pipe 101 by carriage 105. In the present example, cutting tool 106 is configured to cut peels approximately 0.25 inches in width, but other widths may be selected for different examples of the cutting tool.

As shown in FIGS. 1-6B, cutting tool 106 includes a cutting blade 118 and a blade holder 140. Cutting blade 118 is removably mounted in blade holder 140. Blade holder 140 secures cutting blade 118 by compressing cutting blade 118 against blade holder 140.

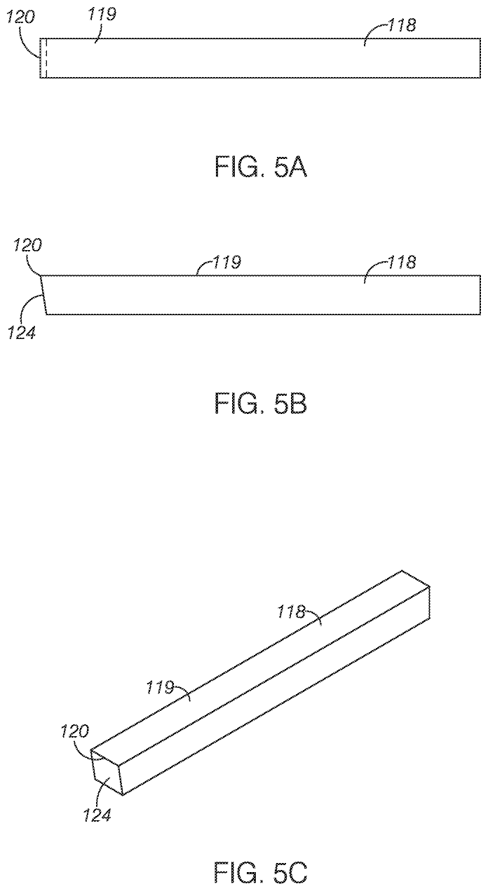

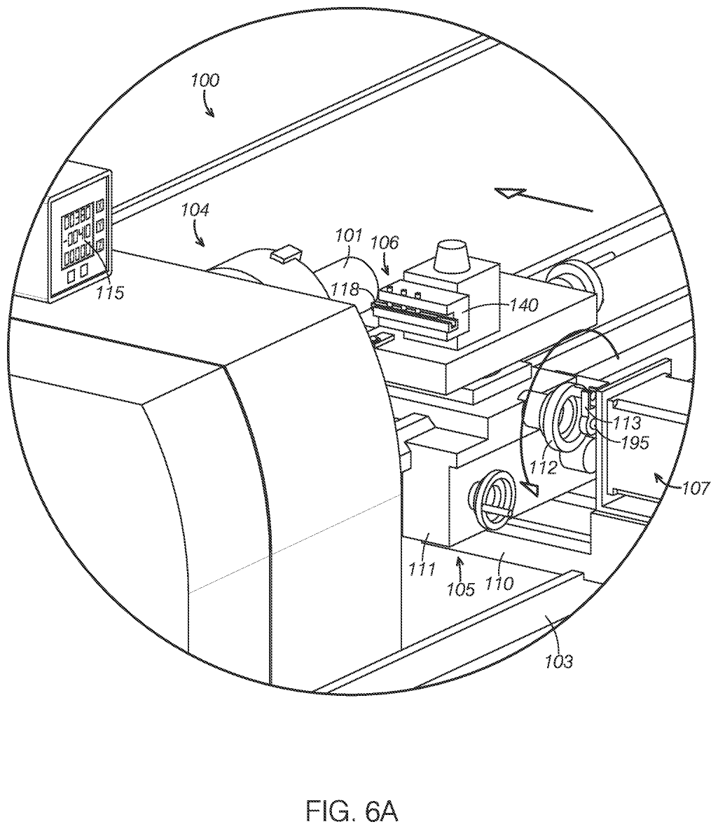

The reader can see in FIGS. 5A-5C that cutting blade 118 includes a leading face 119 and a common edge 120. With reference to FIGS. 5B and 5C, angled face 124 shares common edge 120 with leading face 119. As shown in FIGS. 1-6B, pipe 101 rotates towards leading face 119, and angled face 124 is oriented transverse to leading face 119.

In the example depicted in FIGS. 5B and 5C, leading face 119 and angled face 124 form a 10 degree angle between them. In other examples, the leading face and the angled face form an angle less than 10 degrees between them. As shown in FIG. 6B, the angle formed between leading face 119 and angled face 124 provides clearance between cutting blade 118 and the remainder of pipe 101 as cutting blade 118 cuts a peel from pipe 101.

The reader can see in FIGS. 1-6B that leading face 119 extends parallel to longitudinal axis 102 of pipe 101 in a first dimension and extends perpendicular to longitudinal axis 102 of pipe 101 in a second dimension. As depicted in FIGS. 1, 2, and 5A-5C, common edge 120 extends in the first dimension parallel to longitudinal axis 102 to enable cutting blade 118 to cut peels from pipe 101 with the same depth across the width of the peel.

In the present example, common edge 120 is approximately 0.25 inches long to cut peels from pipe 101 that are approximately 0.25 inches in width. In other examples, the length of the common edge is longer or shorter than 0.25 inches.

The cutting blade may be any currently known or later developed type of cutting blade suitable for microtoming a pipe. The reader will appreciate that a variety of cutting blade types exist and could be used in place of the cutting blade shown in the figures. In addition to the types of cutting blades existing currently, it is contemplated that the systems described herein could incorporate new types of cutting blades developed in the future.

In the present example, cutting blade 118 is composed of a tungsten-cobalt-vanadium steel alloy. In particular, cutting blade 118 is composed of tungsten-colbalt-vanadium super high-speed steel (PM T15 High-Speed Steel). However, the cutting blade may be composed of any currently known or later developed material suitable for the applications described herein for which it is used.

The size and shape of the cutting blade may be varied as needed for a given application. In the present example, cutting blade 118 is approximately 3 inches in length, 0.25 inches in width, and 0.25 inches in thickness. However, in some examples, the cutting blade is larger relative to the other components than depicted in the figures. In other examples, the cutting blade is smaller relative to the other components than depicted in the figures. Further, the reader should understand that the cutting blade and the other components may all be larger or smaller than described herein while maintaining their relative proportions.

Actuator

Actuator 107 functions to move carriage 105 via position dial 112. In particular, as shown in FIGS. 1-4, 6A, and 6B, actuator 107 is configured to move carriage 105 via position dial 112 to different radial positions perpendicular to longitudinal axis 102 of pipe 101.

As shown in FIGS. 1-4, 6A, and 6B, actuator 107 is operatively supported on frame 103. Actuator is supported on frame 103 proximate to position dial 112.

With reference to FIGS. 1-4, 6A, and 6B, actuator 107 includes a control arm 113. In the present example, control arm 113 is coupled to a spindle 195 of actuator 107. Control arm 113 is drivingly coupled to position dial 112. Control arm 113 is configured to selectively rotate position dial 112.

Control arm 113 allows actuator 107 to be mounted in a variety of positions relative to position dial 112 while still being able to drive position dial 112. The design of control arm 113 allows for the spindle axis of actuator 107 to be mounted within a few degrees of precision to position dial 112.

The reader can see in FIGS. 1-4, 6A, and 6B that actuator 107 is a motor. In particular actuator 107 is a stepper motor. However, the actuator may be any currently known or later developed type of actuator. A variety of actuator types exist and could be used in place of the actuator shown in the figures. In addition to the types of actuators existing currently, it is contemplated that the systems described herein could incorporate new types of actuators developed in the future.

In the example shown in the figures, actuator 107 is controlled by computer software. A user can input the lathe rotation or the lathe rotation can be automatically obtained by an encoder on a spindle of lathe 104.

In the present example, a user inputs into the software the rotation distance of position dial 112 per 1 degree of rotation. The user may then input a desired peel depth in unit inches. The software is programmed to calculate and control actuator 107 to rotate position dial 112 such that one rotation of the lathe spindle equals the desired thickness of the peel.

The software in the present example is programmed to respond to two switches on controller 116. First switch 191 controls the direction of rotation of actuator 107. Second switch 192 controls when actuator 107 rotates in a direction established by first switch 191.

When second switch 192 is pressed, actuator 107 rotates position dial 112, which moves carriage 105 towards pipe 101 until cutting tool 106 moves into pipe 101 a predetermined distance in two rotations of pipe 101. When first switch 191 is pressed to reverse the direction that actuator 107 rotates, subsequently pressing second switch 192 rotates position dial 112 in the opposite direction, which moves carriage 105 away from pipe 101 and cutting tool 106 backs out of pipe 101 a predetermined distance. When cutting tool 106 backs out of pipe 101, cutting tool may be quickly cleaned and then resume cutting peels.

Position Sensor

The position sensor functions to detect the position of cutting tool 106 relative to pipe 101. In the example shown in FIGS. 1-4, the position sensor is configured to detect the radial position of cutting tool 106. In particular, the position sensor is configured to detect the position of common edge 120 relative to the inner diameter of pipe 101. Additionally or alternatively, the position sensor may detect the position of the common edge relative to the outer diameter or longitudinal axis of the pipe and/or to a given baseline position on lathe 104.

The number of position sensors in the system may be selected to meet the needs of a given application. The reader should appreciate that the number of position sensors may be different in other examples than is shown in the figures. For instance, some system examples include additional or fewer position sensors than described in the present example.

The position sensor may be any currently known or later developed type of position sensor. The reader will appreciate that a variety of position sensor types exist and could be used in place of the position sensor shown in the figures. In addition to the types of position sensors existing currently, it is contemplated that the systems described herein could incorporate new types of position sensors developed in the future.

Computer Display

Computer display 115 functions to display information regarding operating parameters for microtome system 100 and the current position of components of microtome system 100. For example, computer display 115 is configured to display information related to the radial position of cutting tool 106 relative to pipe 101. In particular, computer display 115 is configured to display the position of common edge 120 of cutting tool 106 relative to the inner diameter of pipe 101. Additionally or alternatively, the computer display may display the position of the common edge relative to the outer diameter or longitudinal axis of the pipe.

The reader can see in FIGS. 1-4 that computer display 115 is in data communication with controller 116 and actuator 107. Additionally or alternatively, the computer display may be in data communication with the position sensor.

The size and shape of the computer display may be varied as needed for a given application. In some examples, the computer display is larger relative to the other components than depicted in the figures. In other examples, the computer display is smaller relative to the other components than depicted in the figures. Further, the reader should understand that the computer display and the other components may all be larger or smaller than described herein while maintaining their relative proportions.

The computer display may be any currently known or later developed type of computer display. The reader will appreciate that a variety of computer display types exist and could be used in place of the computer display shown in the figures. In addition to the types of computer displays existing currently, it is contemplated that the systems described herein could incorporate new types of computer displays developed in the future.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for circumferentially microtoming a pipe having a longitudinal axis, the system comprising:
a frame;
a lathe mounted to the frame and configured to support and rotate the pipe about the longitudinal axis of the pipe;
a carriage operatively supported on the frame proximate an outer circumference of the pipe;
a cutting tool mounted to the carriage and configured to cut microtome peels of selected thickness from the outer circumference of the pipe when the cutting tool engages the outer circumference of the pipe; and
an actuator operatively supported on the frame and configured to move the carriage to different radial positions perpendicular to the longitudinal axis of the pipe;
wherein the different radial positions are selected to position the cutting tool to cut microtome peels of the selected thickness from the outer circumference of the pipe.

2. The system of claim 1, wherein the pipe is comprised of plastic.

3. The system of claim 1, wherein the actuator is a motor.

4. The system of claim 3, wherein the actuator is a stepper motor.

5. The system of claim 3, wherein the carriage includes:
a rail; and
a sled moveably mounted on the rail and supporting the cutting tool.

6. The system of claim 5, wherein the carriage includes a position dial configured to translate the sled relative to the rail when the position dial rotates.

7. The system of claim 6, wherein the actuator includes a control arm drivingly coupled to the position dial and configured to selectively rotate the position dial.

8. The system of claim 1, further comprising a position sensor configured to detect a current radial position of the cutting tool as the actuator moves the cutting tool to each of the different radial positions.

9. The system of claim 8, further comprising a computer display in data communication with the position sensor and configured to display information related to the radial position of the cutting tool.

10. The system of claim 1, further comprising a controller configured to selectively actuate the actuator based on programmed instructions.

11. The system of claim 10, wherein the controller is further configured to selectively activate the lathe to rotate the pipe based on programmed instructions.

12. The system of claim 11, wherein the programmed instructions include instructions to activate the lathe to rotate the pipe over a selected angle.

13. The system of claim 12, wherein the selected angle is 720 degrees.

14. The system of claim 1, wherein the cutting tool includes a cutting blade.

15. The system of claim 14, wherein the cutting blade includes:
a leading face towards which the pipe rotates; and
an angled face sharing a common edge with the leading face and oriented transverse to the leading face.

16. (canceled)

17. The system of claim 11, wherein the common edge extends parallel to the longitudinal axis of the pipe.

18. (canceled)

19. The system of claim 14, wherein the cutting blade is formed from a tungsten-cobaltvanadium steel alloy.

20. The system of claim 1, wherein the lathe includes a support mount configured to support the pipe from inside the pipe.

21. The system of claim 5, wherein the position dial is calibrated to translate the sled a selected distance that positions the cutting tool to cut microtome peels of the selected thickness from the outer circumference of the pipe.
